(19) United States
(12) Patent Application Publication
(10) Pub. No.: US 2026/0169759 A1
(43) Pub. Date: Jun. 18, 2026

(54) SYSTEM AND METHOD FOR SEAMLESS INTEGRATION WITH MODULAR AND CONFIGURABLE ROUTES

(71) Applicant: JPMorgan Chase Bank, N.A., New York, NY (US)

(72) Inventors: Shamanth MURTHY, Bengaluru (IN); Ramakrishna AMBATIPUDI, Bangalore (IN); Magesh LAKSHMI, Aurora, IL (US)

(73) Assignee: JPMorgan Chase Bank, N.A., New York, NY (US)

(21) Appl. No.: 19/040,557

(22) Filed: Jan. 29, 2025

(30) Foreign Application Priority Data
Dec. 17, 2024 (IN) 202411099872

(51) Int. Cl. G06F 9/445; G06F 8/41; G06F 40/284; H04L 67/02

(52) U.S. Cl. CPC G06F 9/44505; G06F 8/433; G06F 40/284; H04L 67/02

(57) ABSTRACT

Various methods and processes, apparatuses/systems, and media for integrating disparate systems, i.e., systems, applications, data sources, etc., are disclosed. A processor creates configurable and reusable components designed to adapt to diverse integration needs of the disparate systems within an integration process; generates a custom script corresponding to each component that defines how the configurable and reusable components are interconnected utilizing integration patterns; implements a dynamic flow executor within an integration framework that translates the custom script into actionable integration process components corresponding to the configurable and reusable components by applying the integration patterns and constructing a persistent flow context; generates tokens to orchestrate execution of the actionable integration process components, the tokens indicating a precise order of execution of the actionable integration process components as defined by the custom script; and dynamically and automatically integrates the disparate systems based on executing the tokens and the persistent flow context.

### CROSS-REFERENCE TO RELATED APPLICATIONS

This application claims the benefit of priority from Indian Provisional Patent Application No. 202411099872, filed Dec. 17, 2024, which is herein incorporated by reference in its entirety.

### TECHNICAL FIELD

This disclosure generally relates to data processing, and, more particularly, to methods and apparatuses for implementing a platform, language, cloud, and database agnostic seamless enterprise integration module configured to streamline and simplify complex integration processes with modular and configurable routes.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Enterprises typically use a wide variety of commercial software applications for different purposes and operations such as, e.g., financial, human resources, sales management, email, e-commerce, and many other such disparate systems, applications, and data sources. Different resources and specialized personnel may be needed to install, maintain and integrate these disparate systems, applications, and data sources as well as to reconfigure the systems with updates that may result in these disparate systems, applications, and data sources no longer functioning due to changes and resultant compatibility changes.

For example, the integration of disparate systems, applications, and data sources typically involves the translation of data formats and correlation of events between those two systems. Business logic may provide the mapping between the two systems. Because this business logic may be external to each system, an external execution environment may be required to support the processing of business logic. The fundamental barriers to integrating applications appears to be incompatible data formats (the format in which data relevant to each system may be stored and accessed) and incompatible event models (the methods by which system events may be invoked and carried out). The result may prove to be an impedance mismatch that prevents disparate applications from communicating and sharing information.

Moreover, enterprise integration projects may pose significant challenges for organizations, as the complexities of connecting disparate systems, applications, and data sources, applications, and data sources discussed earlier may lead to protracted development cycles, increased maintenance costs, and hindered scalability. Inefficient integration practices often result in redundancies, manual coding effort, and lack of standardized approaches, impeding seamless communication and data exchange.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic seamless enterprise integration module configured to streamline and simplify complex integration processes with modular and configurable routes, but the disclosure is not limited thereto.

In some embodiments, a method for integrating disparate systems, applications, and data sources by utilizing one or more processors along with allocated memory is disclosed. The method may include: creating configurable and reusable components designed to adapt to diverse integration needs of the disparate systems, applications, and data sources within an integration process; generating a custom script corresponding to each component that defines how the configurable and reusable components are interconnected utilizing integration patterns; implementing a dynamic flow executor within an integration framework that translates the custom script into actionable integration process components corresponding to the configurable and reusable components by applying the integration patterns and constructing a persistent flow context; generating tokens to orchestrate execution of the actionable integration process components, wherein the tokens indicate a precise order of execution of the actionable integration process components as defined by the custom script; and dynamically and automatically integrating the disparate systems, applications, and data sources based on executing the tokens and the persistent flow context.

In some embodiments, the configurable and reusable components may correspond to integration blocks for integrating the disparate systems, applications, and data sources by exposing the integration process as configuration-as-code.

In some embodiments, one of the configurable and reusable components may be a representational state transfer integration component within the integration process that exposes one or more configuration options.

In some embodiments, in exposing one or more configuration options, the method may further include: exposing an endpoint specifying a universal resource locator of a representational state transfer service to connect with corresponding to the representational state transfer integration component; defining a type of hypertext transport protocol request to be used; configuring a type of authentication needed to integrate the disparate systems, applications, and data sources; and setting rules for validating responses received from the representational state transfer service.

In some embodiments, in generating the custom script, the method may further include: defining the integration process in custom domain-specific language, wherein the custom domain-specific language may include one or more of the following: object-oriented programming language, extensible markup language, static and dynamic language, and human-readable data serialization language, but the disclosure is not limited thereto.

In some embodiments, the method may further include: tracking each step of the integration process in real time by utilizing a user interface.

In some embodiments, the persistent flow context may represent a durable blueprint of the integration process, and the method may further include: detecting errors in the integration process; automatically notifying a user of the dynamic flow executor the detected errors; and executing automatic retries to resolve the detected errors.

In some embodiments, a system for integrating disparate systems, applications, and data sources is disclosed. The system may include: a processor; a plurality of disparate systems, applications, and data sources, and a memory operatively connected to the processor and the disparate systems, applications, and data sources via a communication interface, the memory storing computer readable instructions, when executed, may cause the processor to: create configurable and reusable components designed to adapt to diverse integration needs of the disparate systems, applications, and data sources within an integration process; generate a custom script corresponding to each component that defines how the configurable and reusable components are interconnected utilizing integration patterns; implement a dynamic flow executor within an integration framework that translates the custom script into actionable integration process components corresponding to the configurable and reusable components by applying the integration patterns and constructing a persistent flow context; generate tokens to orchestrate execution of the actionable integration process components, wherein the tokens indicate a precise order of execution of the actionable integration process components as defined by the custom script; and dynamically and automatically integrate the disparate systems, applications, and data sources based on executing the tokens and the persistent flow context.

In some embodiments, in the system, the configurable and reusable components may correspond to integration blocks for integrating the disparate systems, applications, and data sources by exposing the integration process as configuration-as-code.

In some embodiments, in the system, one of the configurable and reusable components may be a representational state transfer integration component within the integration process that exposes one or more configuration options.

In some embodiments, in exposing one or more configuration options, the processor may be further configured to: expose an endpoint specifying a universal resource locator of a representational state transfer service to connect with corresponding to the representational state transfer integration component; define a type of hypertext transport protocol request to be used; configure a type of authentication needed to integrate the disparate systems, applications, and data sources; and set rules for validating responses received from the representational state transfer service.

In some embodiments, in generating the custom script, the processor may be further configured to: define the integration process in custom domain-specific language, wherein the custom domain-specific language may include one or more of the following: object-oriented programming language, extensible markup language, static and dynamic language, and human-readable data serialization language, but the disclosure is not limited thereto.

In some embodiments, the processor may be further configured to: track each step of the integration process in real time by utilizing a user interface.

In some embodiments, in the system, the persistent flow context may represent a durable blueprint of the integration process, and the processor may be further configured to: detect errors in the integration process; automatically notify a user of the dynamic flow executor the detected errors; and execute automatic retries to resolve the detected errors.

In some embodiments, a non-transitory computer readable medium configured to store instructions for integrating disparate systems, applications, and data sources is disclosed. The instructions, when executed, may cause a processor to perform the following: creating configurable and reusable components designed to adapt to diverse integration needs of the disparate systems, applications, and data sources within an integration process; generating a custom script corresponding to each component that defines how the configurable and reusable components are interconnected utilizing integration patterns; implementing a dynamic flow executor within an integration framework that translates the custom script into actionable integration process components corresponding to the configurable and reusable components by applying the integration patterns and constructing a persistent flow context; generating tokens to orchestrate execution of the actionable integration process components, wherein the tokens indicate a precise order of execution of the actionable integration process components as defined by the custom script; and dynamically and automatically integrating the disparate systems, applications, and data sources based on executing the tokens and the persistent flow context.

In some embodiments according to the non-transitory computer readable medium, the configurable and reusable components may correspond to integration blocks for integrating the disparate systems, applications, and data sources by exposing the integration process as configuration-as-code.

In some embodiments according to the non-transitory computer readable medium, one of the configurable and reusable components may be a representational state transfer integration component within the integration process that exposes one or more configuration options.

In some embodiments, in exposing one or more configuration options, the instructions, when executed, may cause the processor to further perform the following: exposing an endpoint specifying a universal resource locator of a representational state transfer service to connect with corresponding to the representational state transfer integration component; defining a type of hypertext transport protocol request to be used; configuring a type of authentication needed to integrate the disparate systems, applications, and data sources; and setting rules for validating responses received from the representational state transfer service.

In some embodiments, in generating the custom script, the instructions, when executed, may cause the processor to further perform the following: defining the integration process in custom domain-specific language, wherein the custom domain-specific language may include one or more of the following: object-oriented programming language, extensible markup language, static and dynamic language, and human-readable data serialization language, but the disclosure is not limited thereto.

In some embodiments, the instructions, when executed, may cause the processor to further perform the following: tracking each step of the integration process in real time by utilizing a user interface.

In some embodiments, the persistent flow context may represent a durable blueprint of the integration process, and the instructions, when executed, may cause the processor to further perform the following: detecting errors in the integration process; automatically notifying a user of the dynamic flow executor the detected errors; and executing automatic retries to resolve the detected errors.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic seamless enterprise integration module configured to streamline and simplify complex integration processes with modular and configurable routes in accordance with an embodiment.

FIG. 2 illustrates a diagram of a network environment with a platform, language, database, and cloud agnostic seamless enterprise integration device in accordance with an embodiment.

FIG. 3 illustrates a system diagram for implementing a platform, language, database, and cloud agnostic seamless enterprise integration device having a platform, language, database, and cloud agnostic seamless enterprise integration module in accordance with an embodiment.

FIG. 4 illustrates a system diagram for implementing a platform, language, database, and cloud agnostic seamless enterprise integration module of FIG. 3 in accordance with an embodiment.

FIG. 5 illustrates an integration flow eco system implemented by the platform, language, database, and cloud agnostic seamless enterprise integration module of FIG. 4 for streamlining and simplifying complex integration processes with modular and configurable routes in accordance with an embodiment.

FIG. 6 illustrates an integration framework included within the integration flow eco system of FIG. 5 as implemented by the platform, language, database, and cloud agnostic seamless enterprise integration module of FIG. 4 for streamlining and simplifying complex integration processes with modular and configurable routes in accordance with an embodiment.

FIG. 7 illustrates a flow chart of a process implemented by the platform, language, database, and cloud agnostic seamless enterprise integration module of FIG. 4 for streamlining and simplifying complex integration processes with modular and configurable routes in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in may include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As mentioned earlier, the integration of disparate systems, applications, and data sources typically involves the translation of data formats and correlation of events between those two systems. Business logic may provide the mapping between the two systems. Because this business logic may be external to each system, an external execution environment may be required to support the processing of business logic. The fundamental barriers to integrating applications appears to be incompatible data formats (the format in which data relevant to each system may be stored and accessed) and incompatible event models (the methods by which system events may be invoked and carried out). The result may prove to be an impedance mismatch that prevents disparate applications from communicating and sharing information.

Moreover, enterprise integration projects may pose significant challenges for organizations, as the complexities of connecting disparate systems, applications, and data sources, applications, and data sources discussed earlier may lead to protracted development cycles, increased maintenance costs, and hindered scalability. Inefficient integration practices often result in redundancies, manual coding effort, and lack of standardized approaches, impeding seamless communication and data exchange.

For example, there appears to be problems in conventional approaches with trying to enable large numbers of disparate systems, applications, and data sources to interact because they are subject to transport level failures. Any solution should overcome this shortcoming, providing some measure of guaranteed message delivery. Moreover, the internal system level events, which trigger the internal business logic of each system, should be correlated. It may be deduced that this data conversion and event model correlation requires some level processing external to either system. Another problem with conventional systems is that they do not support the wide scale implementation of system level interoperability. There are many ways to accomplish this goal and many tools on the market support the development of such solutions. But these tools generally do not support ‘mass implementation’ of system level interoperability.

Recent industry surveys indicates that a considerable portion of project's budgets and resources are allocated to custom development, diverting valuable time and effort away from core business objectives. Moreover, the absence of standardized and reusable integration framework compounds the problem, limiting the organization's ability to adapt swiftly to evolving integrations requirements. In light of these challenges, there appears to be a pressing need for a generic enterprise integration framework that promotes code as configuration.

The present disclosure, through one or more of its various aspects, embodiments, and/or specific features or sub-components, provides, among other features, various systems, servers, devices, methods, media, programs, and platforms for implementing a platform, language, cloud, and database agnostic seamless enterprise integration module acting as a generic integration framework that may be configured to streamline and simplify complex integration processes with modular and configurable routes, but the disclosure is not limited thereto. For example, the seamless enterprise integration module disclosed herein may be configured to: customize configurable and reusable routes, akin to building blocks, that may be easily adapted to meet diverse integration needs, thereby ensuring flexibility and scalability, reducing time-to-market and development costs; incorporating a bespoke descriptive language that may enable the easy stitching of different routes to form complex integration flows, thereby simplifying the creation and management of intricate workflows, enhancing operational efficiency; implement a runtime engine that supports hot deployment, self-recovery, and automatic notifications, ensuring robust and resilient integrations, but the disclosure is not limited thereto.

Thus, the seamless enterprise integration module disclosed herein may be configured to develop a comprehensive solution for enterprise systems integration. Such a solution aims to alleviate development burdens by enabling developers to articulate integration logic through configuration rather than relying on traditional, labor-intensive custom coding. For example, the discloses features such as modular routes, a visual designer application, and a robust runtime engine enable organizations to streamline development processes, enhance scalability, and reduce operational costs. The seamless enterprise integration module disclosed herein may be configured to support hot deployment, self-recovery, and end-to-end traceability thereby ensuring resilience and reliability in integration operations.

The custom domain-specific language disclosed herein may simplify the creation and management of integration workflows, making it accessible to users with varying technical skills. This democratization of integration design, combined with the framework's cost efficiency, positions integration flows as a valuable tool for businesses seeking to optimize their processes and protect underlying networks from vulnerable attacks. The seamless enterprise integration module disclosed herein may be further configured to implement artificial intelligence-driven optimization, natural language integration, and security enhancements to meet diverse industry needs and empowering organizations to overcome integration challenges efficiently and effectively, while paving the way for future growth and innovation.

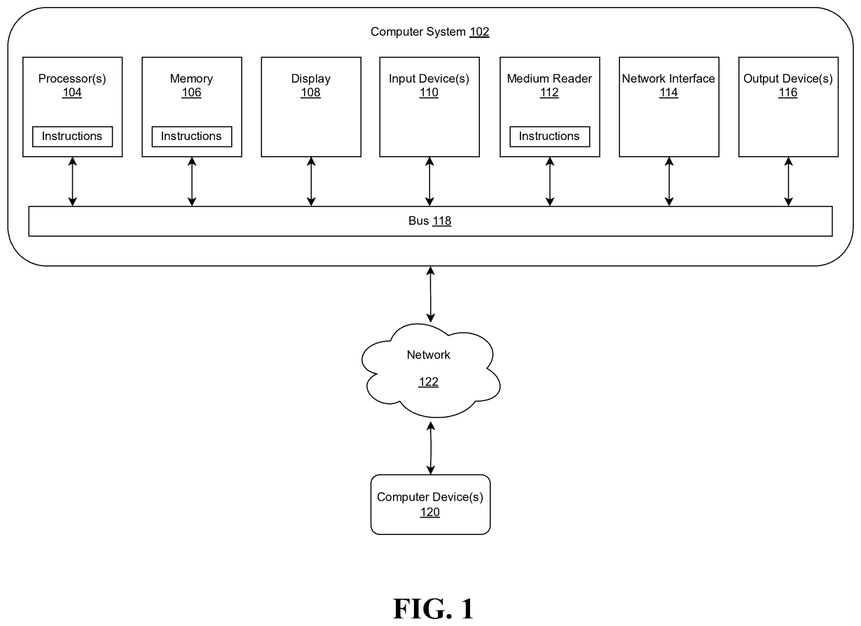

FIG. 1 is an exemplary system 100 for use in implementing a platform, language, database, and cloud agnostic seamless enterprise integration module configured to streamline and simplify complex integration processes with modular and configurable routes in accordance with an exemplary embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. In some embodiments, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 may be tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, in some embodiments, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. In some embodiments, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the seamless enterprise integration module may be platform, language, database, and cloud agnostic that may allow for consistent easy orchestration and passing of data through various components to output a desired result regardless of platform, browser, language, database, and cloud environment. Since the disclosed process, in some embodiments, may be platform, language, database, browser, and cloud agnostic, the seamless enterprise integration module may be independently tuned or modified for optimal performance without affecting the configuration or data files. The configuration or data files, in some embodiments, may be written using JSON, but the disclosure is not limited thereto. In some embodiments, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations may include distributed processing, component/object distributed processing, and an operation mode having parallel processing capabilities. Virtual computer system processing may be constructed to implement one or more of the methods or functionalities as described herein, and a processor described herein may be used to support a virtual processing environment.

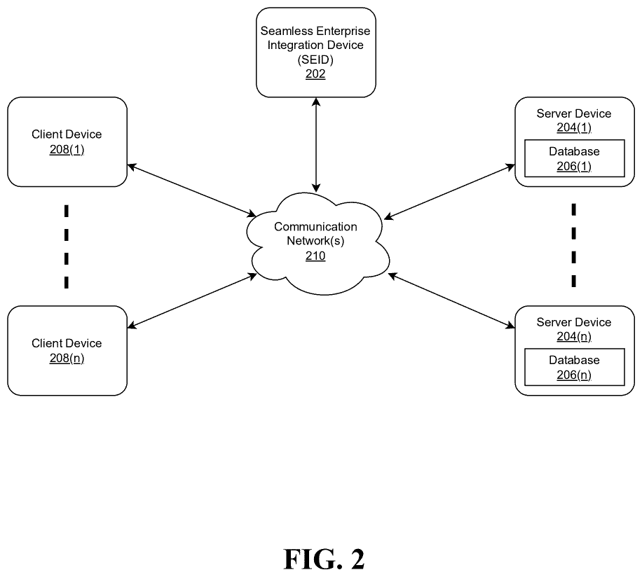

Referring to FIG. 2, a schematic of an exemplary network environment 200 for implementing a language, platform, database, and cloud agnostic seamless enterprise integration device (SEID) of the instant disclosure is illustrated.

In some embodiments, the above-described problems associated with conventional tools may be overcome by implementing an SEID 202 as illustrated in FIG. 2 that may be configured for implementing a platform, language, database, and cloud agnostic seamless enterprise integration module configured to streamline and simplify complex integration processes with modular and configurable routes, but the disclosure is not limited thereto.

The SEID 202 may have one or more computer system 102s, as described with respect to FIG. 1, which in aggregate provide the necessary functions.

The SEID 202 may store one or more applications that may include executable instructions that, when executed by the SEID 202, cause the SEID 202 to perform actions, such as to transmit, receive, or otherwise process network messages, in some embodiments, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the SEID 202 itself, may be located in virtual server(s) running in a cloud-based computing environment rather than being tied to one or more specific physical network computing devices. Also, the application(s) may be running in one or more virtual machines (VMs) executing on the SEID 202. Additionally, in one or more embodiments of this technology, virtual machine(s) running on the SEID 202 may be managed or supervised by a hypervisor.

In the network environment 200 of FIG. 2, the SEID 202 may be coupled to a plurality of server devices 204(1)-204(n) that hosts a plurality of databases 206(1)-206(n), and also to a plurality of client devices 208(1)-208(n) via communication network(s) 210. A communication interface of the SEID 202, such as the network interface 114 of the computer system 102 of FIG. 1, operatively couples and communicates between the SEID 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the SEID 202, the server devices 204(1)-204(n), and/or the client devices 208(1)-208(n) may be coupled together via other topologies. Additionally, the network environment 200 may include other network devices such as one or more routers and/or switches, in some embodiments, which are well known in the art and thus will not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, in some embodiments, teletraffic in any suitable form (e.g., voice, modem, and the like), Public Switched Telephone Network (PSTNs), Ethernet-based Packet Data Networks (PDNs), combinations thereof, and the like.

The SEID 202 may be a standalone device or integrated with one or more other devices or apparatuses, such as one or more of the server devices 204(1)-204(n). In some embodiments, the SEID 202 may be hosted by one of the server devices 204(1)-204(n), and other arrangements may also be possible. Moreover, one or more of the devices of the SEID 202 may be in the same or a different communication network including one or more public, private, or cloud networks, in some embodiments.

The plurality of server devices 204(1)-204(n) may be the same or similar to the computer system 102 or the computer device 120 as described with respect to FIG. 1, including any features or combination of features described with respect thereto. In some embodiments, any of the server devices 204(1)-204(n) may include, among other features, one or more processors, a memory, and a communication interface, which may be coupled together by a bus or other communication link, although other numbers and/or types of network devices may be used. The server devices 204(1)-204(n) in this example may process requests received from the SEID 202 via the communication network(s) 210 according to the HTTP-based and/or JavaScript Object Notation (JSON) protocol, in some embodiments, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that may be configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

In some embodiments, the server devices 204(1)-204(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures may also be envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the SEID 202 that may efficiently provide a platform for implementing a platform, language, database, and cloud agnostic seamless enterprise integration module configured to streamline and simplify complex integration processes with modular and configurable routes as disclosed herein, but the disclosure is not limited thereto.

The client devices 208(1)-208(n) may run interface applications, such as standard web browsers or standalone client applications, which may provide an interface to communicate with the SEID 202 via the communication network(s) 210 in order to communicate user requests. The client devices 208(1)-208(n) may further include, among other features, a display device, such as a display screen or touchscreen, and/or an input device, such as a keyboard, in some embodiments.

Although the exemplary network environment 200 with the SEID 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the SEID 202, the server devices 204(1)-204(n), or the client devices 208(1)-208(n), in some embodiments, may be configured to operate as virtual instances on the same physical machine. In some embodiments, one or more of the SEID 202, the server devices 204(1)-204(n), or the client devices 208(1)-208(n) may operate on the same physical device rather than as separate devices communicating through communication network(s) 210. Additionally, there may be more or fewer SEIDs 202, server devices 204(1)-204(n), or client devices 208(1)-208(n) than illustrated in FIG. 2. In some embodiments, the SEID 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

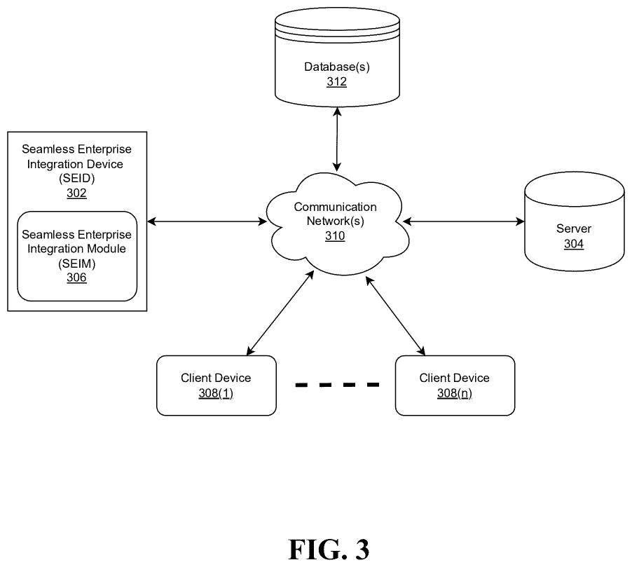

FIG. 3 illustrates a system diagram for implementing a platform, language, and cloud agnostic SEID having a platform, language, database, and cloud agnostic seamless enterprise integration module (SEIM) in accordance with an embodiment.

As illustrated in FIG. 3, the system 300 may include an SEID 302 within which an SEIM 306 may be embedded, a server 304, a database(s) 312, a plurality of client devices 308(1) . . . 308(n), and a communication network 310.

In some embodiments, the SEID 302 including the SEIM 306 may be connected to the server 304, and the database(s) 312 via the communication network 310. The SEID 302 may also be connected to the plurality of client devices 308(1) . . . 308(n) via the communication network 310, but the disclosure is not limited thereto.

According to exemplary embodiment, the SEID 302 is described and shown in FIG. 3 as including the SEIM 306, although it may include other rules, policies, modules, databases, or applications, etc. In some embodiments, the database(s) 312 may be configured to store ready to use modules written for each Application Programming Interface (API) for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto.

In some embodiments, the SEIM 306 may be configured to receive real-time feed of data from the plurality of client devices 308(1) . . . 308(n) and secondary sources via the communication network 310.

As may be described below, the SEIM 306 may be configured to: create configurable and reusable components designed to adapt to diverse integration needs of the disparate systems, applications, and data sources within an integration process; generate a custom script corresponding to each component that defines how the configurable and reusable components are interconnected utilizing integration patterns; implement a dynamic flow executor within an integration framework that translates the custom script into actionable integration process components corresponding to the configurable and reusable components by applying the integration patterns and constructing a persistent flow context; generate tokens to orchestrate execution of the actionable integration process components, wherein the tokens indicate a precise order of execution of the actionable integration process components as defined by the custom script; and dynamically and automatically integrate the disparate systems, applications, and data sources based on executing the tokens and the persistent flow context, but the disclosure is not limited thereto.

The plurality of client devices 308(1) . . . 308(n) are illustrated as being in communication with the SEID 302. In this regard, the plurality of client devices 308(1) . . . 308(n) may be “clients” (e.g., customers) of the SEID 302 and are described herein as such. Nevertheless, it is to be known and understood that the plurality of client devices 308(1) . . . 308(n) need not necessarily be “clients” of the SEID 302, or any entity described in association therewith herein. Any additional or alternative relationship may exist between either or both of the plurality of client devices 308(1) . . . 308(n) and the SEID 302, or no relationship may exist.

The first client device 308(1) may be, in some embodiments, a smart phone. Of course, the first client device 308(1) may be any additional device described herein. The second client device 308(n) may be, in some embodiments, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. In an embodiment, one or more of the plurality of client devices 308(1) . . . 308(n) may communicate with the SEID 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The SEID 302 may be the same or similar to the SEID 202 as described with respect to FIG. 2, including any features or combination of features described with respect thereto.

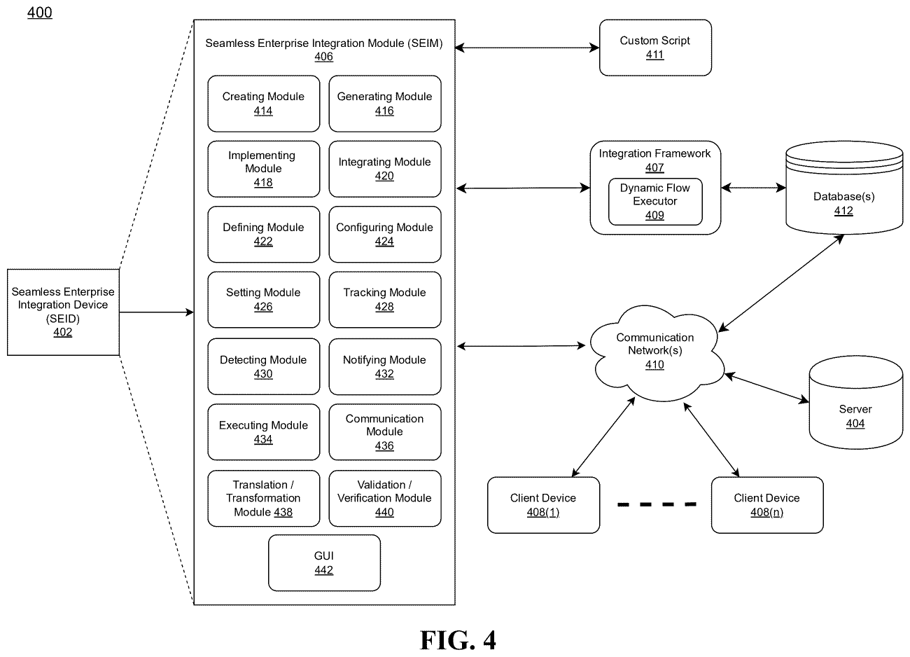

FIG. 4 illustrates a system diagram for implementing a platform, language, database, and cloud agnostic SEIM of FIG. 3 in accordance with an exemplary embodiment.

In some embodiments, the system 400 may include a platform, language, database, and cloud agnostic SEID 402 within which a platform, language, database, and cloud agnostic SEIM 406 may be embedded, a server 404, an integration framework 407 within which a dynamic flow executor 409 may be embedded, database(s) 412, and a communication network 410. In some embodiments, server 404 may comprise a plurality of servers located centrally or located in different locations, but the disclosure is not limited thereto.

In some embodiments, the SEID 402 including the SEIM 406 may be connected to the server 404, the integration framework 407, and the database(s) 412 via the communication network 410. The SEID 402 may also be connected to the plurality of client devices 408(1)-408(n) via the communication network 410, but the disclosure is not limited thereto. The SEIM 406, the server 404, the plurality of client devices 408(1)-408(n), the database(s) 412, the communication network 410 as illustrated in FIG. 4 may be the same or similar to the SEIM 306, the server 304, the plurality of client devices 308(1)-308(n), the database(s) 312, the communication network 310, respectively, as illustrated in FIG. 3.

In some embodiments, as illustrated in FIG. 4, the SEIM 406 may include a creating module 414, a generating module 416, an implementing module 418, an integrating module 420, a defining module 422, a configuring module 424, a setting module 426, a tracking module 428, a detecting module 430, a notifying module 432, an executing module 434, a communication module 436, a translation/transformation module 438, validation/verification module 440 and a Graphical User Interface (GUI) 442. In some embodiments, interactions and data exchange among these modules included in the SEIM 406 provide the advantageous effects of the disclosed invention. Functionalities of each module of FIG. 4 may be described in detail below with reference to FIGS. 4-7.

In some embodiments, each of the creating module 414, generating module 416, implementing module 418, integrating module 420, defining module 422, configuring module 424, setting module 426, tracking module 428, detecting module 430, notifying module 432, executing module 434, communication module 436, translation/transformation module 438, and the validation/verification module 440 of the SEIM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the creating module 414, generating module 416, implementing module 418, integrating module 420, defining module 422, configuring module 424, setting module 426, tracking module 428, detecting module 430, notifying module 432, executing module 434, communication module 436, translation/transformation module 438, and the validation/verification module 440 of the SEIM 406 of FIG. 4 may be implemented by microprocessors or similar, and may be programmed using software (e.g., microcode) to perform various functions discussed herein and may optionally be driven by firmware and/or software.

Alternatively, in some embodiments, each of the creating module 414, generating module 416, implementing module 418, integrating module 420, defining module 422, configuring module 424, setting module 426, tracking module 428, detecting module 430, notifying module 432, executing module 434, communication module 436, translation/transformation module 438, and the validation/verification module 440 of the SEIM 406 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. In some embodiments, the SEIM 406 of FIG. 4 may also be implemented by cloud-based deployment. In some embodiments, a single API call may invoke each of the creating module 414, generating module 416, implementing module 418, integrating module 420, defining module 422, configuring module 424, setting module 426, tracking module 428, detecting module 430, notifying module 432, executing module 434, communication module 436, translation/transformation module 438, and the validation/verification module 440 of the SEIM 406 of FIG. 4 (in complete or in part) either sequentially or parallelly based on flow design, but the disclosure is not limited thereto.

In some embodiments, each of the creating module 414, generating module 416, implementing module 418, integrating module 420, defining module 422, configuring module 424, setting module 426, tracking module 428, detecting module 430, notifying module 432, executing module 434, communication module 436, translation/transformation module 438, and the validation/verification module 440 of the SEIM 406 of FIG. 4 may be called via corresponding API, but the disclosure is not limited thereto. For example, in some embodiments, the creating module 414 may be called via a first API, the generating module 416 may be called via a second API, the implementing module 418 may be called via a third API, the integrating module 420 may be called via a fourth API, the defining module 422 may be called via a fifth API, the configuring module 424 may be called via a sixth API, the setting module 426 may be called via a seventh API, the tracking module 428 may be called via an eight API, the detecting module 430 may called via a ninth API, the notifying module 432 may called via a tenth API, the executing module 434 may be called via an eleventh API, and the communication module 436 may be called via a twelfth API. The translation/transformation module 438 may be called via a thirteenth API. The validation/verification module 440 may be called via a fourteenth API. In some embodiments, calls may also be made using event-based message interfaces in addition to APIs. An event-based message interface may be a design pattern that enables communication between services by defining events and handlers that process them. This approach may allow for efficient communication and decoupled components, which may lead to more flexible and modular systems.

In some embodiments, the process implemented by the SEIM 406 may be executed via the communication module 436, and the communication network 410, which may comprise plural networks as described above. In some embodiments, in an exemplary embodiment, the various components of the SEIM 406 may communicate with the server 404, and the database(s) 412 via the communication module 436 and the communication network 410 and the results may be displayed onto the GUI 442. Of course, these embodiments are merely exemplary and are not limiting or exhaustive. The database(s) 412 may include the databases included within the private cloud and/or public cloud and the server 404 may include one or more servers within the private cloud and the public cloud.

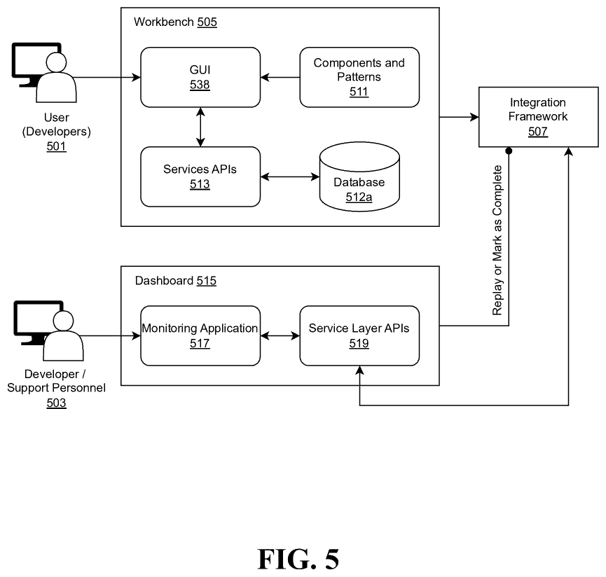

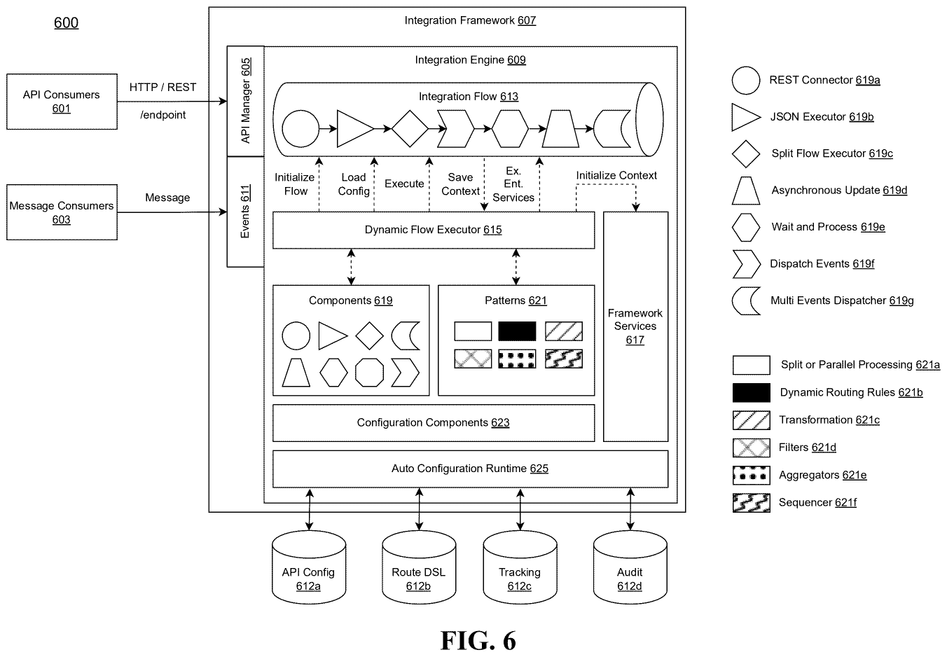

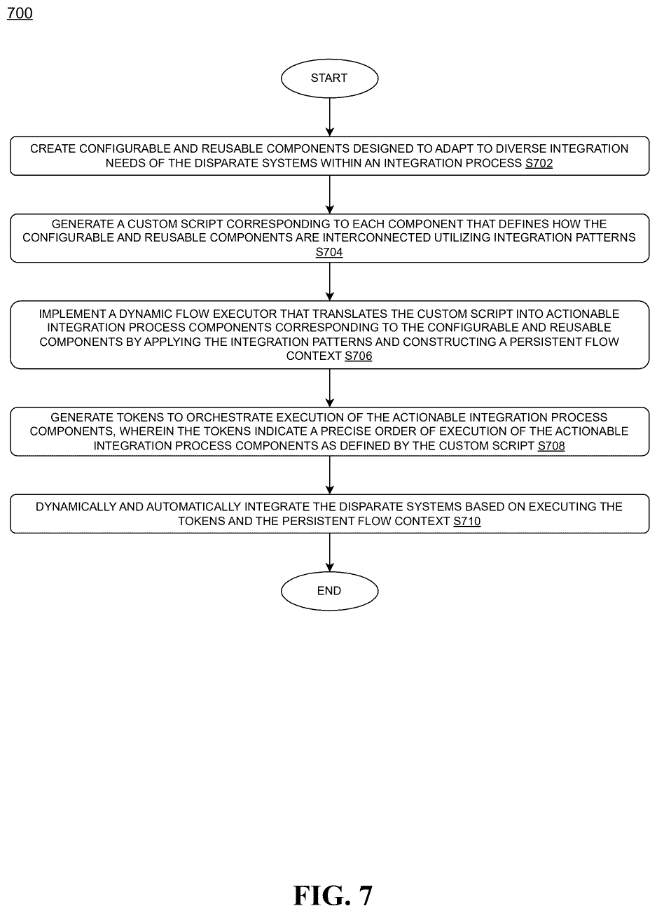

FIG. 5 illustrates an integration flow eco system 500 implemented by the platform, language, database, and cloud agnostic SEIM 406 of FIG. 4 for streamlining and simplifying complex integration processes with modular and configurable routes in accordance with an embodiment. FIG. 6 illustrates an integration framework 600 included within the integration flow eco system 500 of FIG. 5 as implemented by the platform, language, database, and cloud agnostic SEIM 406 of FIG. 4 for streamlining and simplifying complex integration processes with modular and configurable routes in accordance with an embodiment. FIG. 7 illustrates a flow chart of a process 700 implemented by the platform, language, database, and cloud agnostic SEIM 406 of FIG. 4 for streamlining and simplifying complex integration processes with modular and configurable routes in accordance with an embodiment. It may be appreciated that the illustrated process 600 and associated steps may be performed in a different order, with illustrated steps omitted, with additional steps added, or with a combination of reordered, combined, omitted, or additional steps.

As disclosed below with reference to FIGS. 4-7, the SEIM 406 disclosed herein may be configured to: customize configurable and reusable routes, akin to building blocks, that may be easily adapted to meet diverse integration needs, thereby ensuring flexibility and scalability, reducing time-to-market and development costs; incorporating a bespoke descriptive language that may enable the easy stitching of different routes to form complex integration flows, thereby simplifying the creation and management of intricate workflows, enhancing operational efficiency; implement a runtime engine that supports hot deployment, self-recovery, and automatic notifications, ensuring robust and resilient integrations, but the disclosure is not limited thereto.

Thus, the SEIM 406 disclosed herein may be configured to develop a comprehensive solution for enterprise systems integration. Such a solution aims to alleviate development burdens by enabling developers to articulate integration logic through configuration rather than relying on traditional, labor-intensive custom coding. For example, the discloses features such as modular routes, a visual designer application, and a robust runtime engine enable organizations to streamline development processes, enhance scalability, and reduce operational costs. The SEIM 406 disclosed herein may be configured to support hot deployment, self-recovery, and end-to-end traceability thereby ensuring resilience and reliability in integration operations.

The custom domain-specific language (DSL) disclosed herein may simplify the creation and management of integration workflows (i.e., integration workflow 613 as illustrated in FIG. 6), making it accessible to users with varying technical skills. This democratization of integration design, combined with the framework's cost efficiency, positions integration flows as a valuable tool for businesses seeking to optimize their processes and protect underlying networks from vulnerable attacks. The SEIM 406 disclosed herein may be further configured to implement artificial intelligence-driven optimization, natural language integration, and security enhancements to meet diverse industry needs and empowering organizations to overcome integration challenges efficiently and effectively, while paving the way for future growth and innovation.

Referring to FIGS. 4-7, in some embodiments, at step S702, the process 700 may include creating, by calling the creating module 414 (see FIG. 4) via a first API, configurable and reusable components designed to adapt to diverse integration needs of the disparate systems within an integration process.

In some embodiments, at step S704, the process 700 may include generating, by calling the generating module 416 via the second API, a custom script 411 corresponding to each component that defines how the configurable and reusable components (see, e.g., components 619 as illustrated in FIG. 6) are interconnected utilizing integration patterns (see, e.g., patterns 621 as illustrated in FIG. 6). In some embodiments, in generating the custom script at step S704, the process 700 may further include: defining, by calling the defining module 422 (see FIG. 4) via the fifth API, the integration process (see, e.g., integration flow 613 in FIG. 6) in custom DSL, wherein the custom DSL may include one or more of the following: object-oriented programming language, extensible markup language, static and dynamic language, and human-readable data serialization language, but the disclosure is not limited thereto.

In some embodiments, at step S706, the process 700 implemented by the SEIM 406 of FIG. 4 may include, implementing, by calling the implementing module 418 via the third API, a dynamic flow executor 409 (see, also the dynamic flow executor 615 as illustrated in FIG. 6) within an integration framework 407, 607 that translates, by calling the translation/transformation module 438 via the thirteenth API, the custom script 411 into actionable integration process components corresponding to the configurable and reusable components 619 by applying the integration patterns 621 and constructing a persistent workflow context. The dynamic flow executor 615 as illustrated in FIG. 6 may be the same or similar to the dynamic flow executor 409 as illustrated in FIG. 4. Also, the integration framework 407 as illustrated in FIG. 4 may be the same or similar to the integration framework 507 as illustrated in FIG. 5, as well as the integration framework 607 as illustrated in FIG. 6. In some embodiments, the persistent workflow context may represent a durable blueprint of the integration process (i.e., integration flow 613 as illustrated in FIG. 6, and the process 700 at step 706 may further include: detecting, by calling the detecting module 430 via the ninth API, errors in the integration flow 613; automatically notifying, by calling the notifying module 432 via the tenth API, a user (i.e., user 501 and/or developer/support personnel 503 as illustrated in FIG. 5) of the dynamic flow executor 409 in FIG. 4 (or similarly 615 in FIG. 6) the detected errors; and executing, by calling the executing module 434 via the eleventh API, automatic retries to resolve the detected errors.

As illustrated in FIG. 6, the components 619 may include a representational state transfer (REST) connector 619a, a JSON executor 619b, a split flow executor 619c, an asynchronous update 619d, a wait and process 619e, dispatch events 619f, multi events dispatcher 619g, etc., but the disclosure is not limited thereto. Also, as illustrated in FIG. 6, the patterns 621 may include split and parallel processing 621a, dynamic routing rules 621b, transformation 621c, filters 621d, aggregators 621e, sequencer 621f, etc., but the disclosure is not limited thereto. In some embodiments, the configurable and reusable components may correspond to integration blocks for integrating the disparate systems, applications, and data sources by exposing the integration process as configuration-as-code. In some embodiments, as discussed earlier, one of the configurable and reusable components may be a REST integration component within the integration process that exposes one or more configuration options.

For example, in exposing the one or more configuration options at step S706, the process 700 may further include: exposing an endpoint specifying a universal resource locator of a REST service to connect with corresponding to the REST integration component discussed above; defining, by calling the defining module 422 (see FIG. 4) via the fifth API, a type of hypertext transport protocol HTTP request to be used (see, e.g., API consumers 601 as illustrated in FIG. 6) and transferring to an API manager 605 (see FIG. 6) within the integration framework 607 (see FIG. 6); configuring, by calling the configuring module 424 (see FIG. 4) via the sixth API a type of authentication needed to integrate the disparate systems, applications, and data sources; and setting, by calling the setting module 426 (see FIG. 4) via the seventh API rules for validating responses received from the REST service. Additionally, the validation/verification module 440 may be called via the fourteenth API for validating responses received from the REST service.

In some embodiments, at step S708, the process 700 implemented by the SEIM 406 of FIG. 4 may include generating, by calling the generating module 416 via the second API, tokens to orchestrate execution of the actionable integration process components (i.e., components 619), wherein the tokens indicate a precise order of execution of the actionable integration process components (i.e., components 619) as defined by the custom script 411 (see FIG. 4).

In some embodiments, at step S710, the process 700 implemented by the SEIM 406 of FIG. 4 may include dynamically and automatically integrating, by calling the integrating module 420 via the fourth API, the disparate systems, applications, and data sources based on executing the tokens and the persistent flow context. In some embodiments, the process 700 at step S710 may further include: tracking, by calling the tracking module 428 via the eighth API, each step of the integration process (i.e., integration flow 613 in FIG. 6) in real time by utilizing a user interface, i.e., GUI 442 as illustrated in FIG. 4, GUI 538 as illustrated in FIG. 5.

Referring back to FIGS. 4-7, supported patterns 621 for flows include: dynamic and conditional routing (i.e., dynamic routing rules 621b in FIG. 6) enabling flexible routing based on dynamic conditions and criteria; sequencer and parallel processing (i.e., split or parallel processing 621a in FIG. 6) supporting sequential and parallel processing of tasks to optimize performance; splitter and aggregators (i.e., aggregators 621e in FIG. 6) facilitating the decomposition of messages for concurrent processing and the subsequent aggregation of responses, optimizing data handling efficiency; enhanced DSLs for pause and resume providing advanced DSLs to pause and resume processes with save points and shared context, including nested flows; synchronous and asynchronous flows supporting both synchronous and asynchronous flow executions to meet varied integration requirements; cron job scheduling of the integration flow 613 as cron jobs allowing users to define cron expressions for automated execution at fixed times, dates, or intervals. This feature enables the automation of routine tasks and ensures timely execution of integration flows 613, enhancing operational efficiency.

The integration flow DSL (i.e., DSL 411 in FIG. 4) may serve as the foundational blueprint for systems integration flows 613. It may define how integration flow components discussed above are interconnected using specific integration patterns 621 (see FIG. 6) such as splitters, aggregators, parallel execution, and sequencers, etc. Additionally, it may specify pre-conditions and save points (SP) necessary for executing integration flows 613. This structured approach may ensure that complex processes are clearly defined and easily manageable.

For example, as illustrated in FIG. 5, the user (developers 501) may utilize the workbench 505 and the developer/support personnel 503 may utilize the dashboard 515 to interconnect with the integration framework 507 (or 607 in FIG. 6) for integrating the disparate systems, applications, and data sources consistent with the process 700 disclosed herein. The integration flows DSL and components meta data may be leveraged to build flow visualization. Once business flow is ready, the user (developer) 501 may export and deploy in any integration flow engine (i.e., integration framework 507, 607). The workbench 505 may include a GUI 538 that may receive components and patterns 511 and services APIs 513 (i.e., the APIs discussed above). The services APIs 513 may be accessed from database 512a. The components and patterns 511 may include components 619 as illustrated in FIG. 6 and patterns 621 as illustrated in FIG. 6. The data from the workbench 505 may be utilized by the integration framework 507 for integrating the disparate systems, applications, and data sources consistent with the process 700 disclosed herein.

In some embodiments, the dashboard 515 may include monitoring application 517 and service layer APIs 519 that bidirectionally receive data from the integration framework 507 (607 in FIG. 6) for integrating the disparate systems, applications, and data sources consistent with the process 700 disclosed herein. Dashboard 515 may be a monitoring application to track flow execution and may check if there are any business failures. If required manual retry or MAC (mark as complete) request may be implemented via this dashboard 515. User has ability to check error analysis done for past requests. For example, the dashboard 515 may be utilized by the developer/support personnel 503 to replay or MAC the integration framework 507 (607 in FIG. 6) consistent with the process 700 disclosed herein. The service layer APIs 519 may retrieve execution details for the integration flow engine, i.e., integration framework 507 (607 in FIG. 6). integration framework 507 (607 in FIG. 6). The integration framework 507, 607 may be configured to work as a Platform as a Service (PaaS) which may implement the process 700 disclosed herein. In some embodiments, PaaS may be implemented by the SEIM 406 as a cloud computing service that may provide a development environment for creating, testing, and managing software applications. PaaS may allow developers to build applications without having to manage the underlying infrastructure, such as servers 404, storage, and databases 412.

In some embodiments, the flow illustrated in FIGS. 5 and 6 may illustrate reusable components 619 for different technology integration called routes and those routes may be seamlessly integrated to form integration flow leverage jolt (JSON->JSON, transformation and extraction, etc.). Customized reusable integration routes performs various operations in an integration flow that can be configurable. In some embodiments, such customized reusable integration routes may include: REST API route, jolt transformation route, pausable route, splitter aggregate route, external trigger, write process variable route, read process variable route, domain specific database (or simply, transactional database) read route, domain specific database write route, database route, write/read exchange property route, asynchronous update route, etc., consistent with the components 619 and patterns 621 discussed above, but the disclosure is not limited thereto. These customized reusable integration routes performs various operations in an integration flow that may be configurable consistent with the process 700 disclosed herein.

For example, as illustrated in FIG. 6, the API consumers 601 may transfer data to the API manager 605 by utilizing HTTP/REST/endpoint discussed above. The message consumers 603 may transfer data corresponding to message to events 611. The auto configuration runtime 625 may be bidirectionally communicate with a API configuration database 612a, route DSL database 612b, tracking database 612c, and an audit database 612d to facilitate the integration flow 613 by utilizing components 619, patterns 621 and configuration components 623 as disclosed herein. For example, the components 619 may include the components discussed earlier and patterns 621 may include patterns discussed earlier. The configuration components 623, in some embodiments may include database integration, jolt, cloud native components, messaging, streams, HTTP/REST, staged event-driven architecture (SEDA) (an approach to software architecture that decomposes a complex, event-driven application into a set of stages connected by queues), web socket, etc., but the disclosure is not limited thereto.

In some embodiments, the dynamic flow executor 615 may utilize the components 619 and patterns 621 to execute integration flow 613 within the integration engine 609. The dynamic flow executor 615 may initialize context from framework service 617. In some embodiments, the framework services 617 may include persistence flow context, notification, error handling, replay/retry, authentication services, messaging platform services, audit, scheduler, save points, etc., but the disclosure is not limited thereto. The dynamic flow executor 615 may then initialize flow, load configurations, execute flow, save context, and execute external services consistent with the process 700 discussed earlier.

For example, in a use case scenario where a system failure is notified to the user, the user may utilize the dashboard 515 as illustrated in FIG. 5 for auto retires (delayed retries (i.e., three times, but configurable). If error is persistent then breaks the flow and sends alert to support users. The dashboard 515 may be utilized to enable support for manual retries. Otherwise, automatic retries may be enabled after every one hour for five times, but may be configurable to any desired time period.

In a use case scenario where a business failure is notified to the user, the user may utilize the dashboard 515 as illustrated in FIG. 5 to offer configurable error codes with error details to correct the error and integrate the disparate systems, applications, and data sources in response to correcting the errors. Any error flows may be retried from the same step, or it may be manually replayed from any previous step provided that step is logical save point. Error handling implemented by the process 700 as disclosed herein may provide resiliency to brokers issues; and detect issues and retires messages as batch once brokers are online.

Referring back to FIGS. 4 and 7, in some embodiments, the process 700 implemented by the SEIM 406 as discussed earlier may provide AI-driven optimization. For example, the integration flow discussed herein may incorporate AI-driven predictive analytics to anticipate potential bottlenecks and optimize flow execution in real-time. By analyzing historical data and current conditions, the SEIM 406 may proactively adjust processes to enhance efficiency and performance consistent with the process 700 discussed herein.

In some embodiments, the process 700 implemented by the SEIM 406 as discussed earlier may provide a Natural Language Processing (NLP) interface. For example, the SEIM 406 may implement the GUI 442 as an NLP-based interface to allow users to create and manage integration flows using natural language commands. A user-friendly, drag-and-drop interface may be developed, enabling users to design and manage flows with ease. This visual tool may democratize access to the framework, allowing non-technical users to participate in process design and optimization. For example, users may describe their integration needs in plain language, and the SEIM 406 may automatically generate the corresponding flow.

In some embodiments, the process 700 implemented by the SEIM 406 as discussed earlier may provide chatbot integration capabilities. For example, the SEIM 406 may be utilized to develop chatbots that may assist users in real-time with flow creation, troubleshooting, and optimization using conversational AI.

In some embodiments, the process 700 implemented by the SEIM 406 as discussed earlier may provide enhanced user experience via collaborative features. For example, new features may enable multiple users to collaborate on flow design and management in real-time. This collaborative environment may foster teamwork and innovation, leading to more effective process solutions.

In some embodiments, the process 700 implemented by the SEIM 406 as discussed earlier may be implemented as integrated communication tools. For example, embedding communication tools within the framework discussed herein may facilitate seamless interaction among team members during flow execution. This integration may enhance coordination and reduce response times.

In some embodiments, the process 700 implemented by the SEIM 406 as discussed earlier may provide automated documentation. For example, the SEIM 406 may be configured to utilize NLP to automatically generate documentation for integration flows, making it easier to understand and maintain. For example, as flows are created or modified, the SEIM 406 may be configured to provide clear, human-readable documentation summarizing the changes.

In some embodiments, the process 700 implemented by the SEIM 406 as discussed earlier may ease transition to a cloud-native architecture to ensure scalability, flexibility, and cost-effectiveness. This may allow seamless integration with various cloud services and platforms.

In some embodiments, the process 700 implemented by the SEIM 406 as discussed earlier may provide real-time monitoring and analytics. For example, the SEIM 406 may implement real-time monitoring and analytics dashboards to provide insights into flow performance, resource utilization, and potential issues. This may help in proactive decision-making.

In some embodiments, the process 700 implemented by the SEIM 406 as discussed earlier may be utilized for scalability and performance optimization. For example, the SEIM 406 may implement serverless architecture-transitioning to a serverless architecture may enhance the framework's scalability and reduce operational costs. This approach may allow the SEIM 406 to automatically scale resources based on demand, ensuring consistent performance. Edge Computing-by leveraging edge computing, the SEIM 406 may process data closer to its source, reducing latency and improving performance. This capability may be particularly beneficial for time-sensitive applications and distributed environments.

In some embodiments, the process 700 implemented by the SEIM 406 as discussed earlier may provide interoperability and integration. Universal Connectors-A library of universal connectors may be developed by the SEIM 406 to facilitate seamless integration with a wide range of third-party applications and services. This may enable organizations to easily connect their existing systems and data sources to the integration flow framework discussed herein.

In some embodiments, the process 700 implemented by the SEIM 406 as discussed earlier may provide security and compliance enhancements. Advanced Security Protocols-the SEIM 406 may implement known cutting-edge security measures, such as zero-trust architecture and end-to-end encryption, to protect sensitive data and ensure secure operations. Automated Compliance Checks-automated compliance verification implemented by the SEIM 406 may be integrated to ensure adherence to industry standards and regulations. This capability may reduce the risk of non-compliance and associated penalties.

In some embodiments, the process 700 implemented by the SEIM 406 as discussed earlier may implemented for API-First Approach. The SEIM 406 may be configured to adopt an API-first strategy to facilitate easy integration with third-party applications and services, expanding the framework's ecosystem and usability.

In some embodiments, the process 700 implemented by the SEIM 406 as discussed earlier may be implemented for adaptive and self-healing flows. For example, the SEIM 406 may be configured to develop self-healing capabilities that automatically detect and resolve issues within flows, minimizing downtime and manual intervention.

In some embodiments, the process 700 implemented by the SEIM 406 as discussed earlier may provide customizable templates and libraries. For example, the SEIM 406 may be configured to create a library of customizable templates and pre-built components for common business processes, reducing the time and effort required to implement new flows.

In some embodiments, the process 700 implemented by the SEIM 406 as discussed earlier may be utilized for community and marketplace. For example, the SEIM 406 may be configured to build a community and marketplace for developers and businesses to share custom components, plugins, and enhancements, fostering innovation and collaboration.

In some embodiments, the process 700 implemented by the SEIM 406 as discussed earlier may provide comprehensive testing and simulation. Flow Simulation Environment—a simulation environment may be developed by the SEIM 406 to test flows under various scenarios before deployment. This capability may allow users to identify and address potential issues, ensuring reliable and robust operations. Automated Testing Framework—an automated testing framework may be implemented by the SEIM 406 to validate, by calling the validation/verification module 440 via the fourteenth API, the functionality and performance of flows. This may enhance the reliability and quality of the framework, reducing the risk of errors and downtime.

In some embodiments, the SEID 402 may include a memory (e.g., a memory 106 as illustrated in FIG. 1) which may be a non-transitory computer readable medium that may be configured to store instructions for implementing a platform, language, database, and cloud agnostic SEIM 406 for integrating disparate systems, applications, and data sources as disclosed herein. The SEID 402 may also include a medium reader (e.g., a medium reader 112 as illustrated in FIG. 1) which may be configured to read any one or more sets of instructions, e.g., software, from any of the memories described herein. The instructions, when executed by a processor embedded within the SEIM 406 or within the SEID 402, may be used to perform one or more of the processes as described herein. In a particular embodiment, the instructions may reside completely, or at least partially, within the memory 106, the medium reader 112, and/or the processor 104 (see FIG. 1) during execution by the SEID 402.

In some embodiments, the instructions, when executed, may cause a processor embedded within the SEIM 406 or the SEID 402 to perform the following: creating configurable and reusable components designed to adapt to diverse integration needs of the disparate systems, applications, and data sources within an integration process; generating a custom script corresponding to each component that defines how the configurable and reusable components are interconnected utilizing integration patterns; implementing a dynamic flow executor within an integration framework that translates the custom script into actionable integration process components corresponding to the configurable and reusable components by applying the integration patterns and constructing a persistent flow context; generating tokens to orchestrate execution of the actionable integration process components, wherein the tokens indicate a precise order of execution of the actionable integration process components as defined by the custom script; and dynamically and automatically integrating the disparate systems, applications, and data sources based on executing the tokens and the persistent flow context. In some embodiments, the processor may be the same or similar to the processor 104 as illustrated in FIG. 1 or the processor embedded within the SEID 202, SEID 302, SEID 402, and SEIM 406 which may be the same or similar to the processor 104.

In some embodiments according to the non-transitory computer readable medium, the configurable and reusable components may correspond to integration blocks for integrating the disparate systems, applications, and data sources by exposing the integration process as configuration-as-code.

In some embodiments according to the non-transitory computer readable medium, one of the configurable and reusable components may be a REST integration component within the integration process that exposes one or more configuration options.

In some embodiments, in exposing one or more configuration options, the instructions, when executed, may cause the processor 104 to further perform the following: exposing an endpoint specifying a universal resource locator of a representational state transfer service to connect with corresponding to the representational state transfer integration component; defining a type of hypertext transport protocol request to be used; configuring a type of authentication needed to integrate the disparate systems, applications, and data sources; and setting rules for validating responses received from the representational state transfer service.

In some embodiments, in generating the custom script, the instructions, when executed, may cause the processor 104 to further perform the following: defining the integration process in custom domain-specific language, wherein the custom domain-specific language may include one or more of the following: object-oriented programming language, extensible markup language, static and dynamic language, and human-readable data serialization language, but the disclosure is not limited thereto.

In some embodiments, the instructions, when executed, may cause the processor 104 to further perform the following: tracking each step of the integration process in real time by utilizing a user interface.

In some embodiments, the persistent flow context may represent a durable blueprint of the integration process, and the instructions, when executed, may cause the processor 104 to further perform the following: detecting errors in the integration process; automatically notifying a user of the dynamic flow executor the detected errors; and executing automatic retries to resolve the detected errors.

In some embodiments as disclosed above in FIGS. 1-7, technical improvements effected by the instant disclosure may include a platform for implementing a platform, language, database, and cloud agnostic seamless enterprise integration module configured to streamline and simplify complex integration processes with modular and configurable routes, but the disclosure is not limited thereto.

Although the invention has been described with reference to several exemplary embodiments, it is understood that the words that have been used may be words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, method, and uses such as are within the scope of the appended claims.

In some embodiments, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards may be periodically superseded by faster or more efficient equivalents having essentially the same functions. Accordingly, replacement standards and protocols having the same or similar functions may be considered equivalents thereof.

The illustrations of the embodiments described herein are intended to provide a general understanding of the various embodiments. The illustrations are not intended to serve as a complete description of all of the elements and features of apparatus and systems that utilize the structures or method described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for integrating disparate systems by utilizing one or more processors along with allocated memory, the method comprising:
creating configurable and reusable components designed to adapt to diverse integration needs of the disparate systems within an integration process;
generating a custom script corresponding to each component that defines how the configurable and reusable components are interconnected utilizing integration patterns;
implementing a dynamic flow executor within an integration framework that translates the custom script into actionable integration process components corresponding to the configurable and reusable components by applying the integration patterns and constructing a persistent flow context;
generating tokens to orchestrate execution of the actionable integration process components, wherein the tokens indicate a precise order of execution of the actionable integration process components as defined by the custom script; and
dynamically and automatically integrating the disparate systems based on executing the tokens and the persistent flow context.

2. The method of claim 1, wherein the configurable and reusable components correspond to integration blocks for integrating the disparate systems by exposing the integration process as configuration-as-code.

3. The method of claim 2, wherein one of the configurable and reusable components is a representational state transfer integration component within the integration process that exposes one or more configuration options.

4. The method of claim 3, wherein in exposing one or more configuration options, the method further comprising:
exposing an endpoint specifying a universal resource locator of a representational state transfer service to connect with corresponding to the representational state transfer integration component;
defining a type of hypertext transport protocol request to be used;
configuring a type of authentication needed to integrate the disparate systems; and
setting rules for validating responses received from the representational state transfer service.

5. The method of claim 1, wherein in generating the custom script, the method further comprising:
defining the integration process in custom domain-specific language.

6. The method of claim 5, wherein the custom domain-specific language includes one or more of the following: object-oriented programming language, extensible markup language, static and dynamic language, and human-readable data serialization language.

7. The method of claim 1, further comprising:
tracking each step of the integration process in real time by utilizing a user interface.

8. The method of claim 1, wherein the persistent flow context represents a durable blueprint of the integration process, and the method further comprising:
detecting errors in the integration process;
automatically notifying a user of the dynamic flow executor the detected errors; and
executing automatic retries to resolve the detected errors.

9. A system for integrating disparate systems, the system comprising:
a processor;
a plurality of disparate systems; and
a memory operatively connected to the processor and the disparate systems via a communication interface, the memory storing computer readable instructions, when executed, causes the processor to:
create configurable and reusable components designed to adapt to diverse integration needs of the disparate systems within an integration process;
generate a custom script corresponding to each component that defines how the configurable and reusable components are interconnected utilizing integration patterns;
implement a dynamic flow executor within an integration framework that translates the custom script into actionable integration process components corresponding to the configurable and reusable components by applying the integration patterns and constructing a persistent flow context;
generate tokens to orchestrate execution of the actionable integration process components, wherein the tokens indicate a precise order of execution of the actionable integration process components as defined by the custom script; and
dynamically and automatically integrate the disparate systems based on executing the tokens and the persistent flow context.

10. The system of claim 9, wherein the configurable and reusable components correspond to integration blocks for integrating the disparate systems by exposing the integration process as configuration-as-code.

11. The system of claim 10, wherein one of the configurable and reusable components is a representational state transfer integration component within the integration process that exposes one or more configuration options.

12. The system of claim 11, wherein in exposing one or more configuration options, the processor is further configured to:
expose an endpoint specifying a universal resource locator of a representational state transfer service to connect with corresponding to the representational state transfer integration component;
define a type of hypertext transport protocol request to be used;
configure a type of authentication needed to integrate the disparate systems; and
set rules for validating responses received from the representational state transfer service.

13. The system of claim 9, wherein in generating the custom script, the processor is further configured to:
define the integration process in custom domain-specific language.

14. The system of claim 13, wherein the custom domain-specific language includes one or more of the following: object-oriented programming language, extensible markup language, static and dynamic language, and human-readable data serialization language.

15. The system of claim 9, wherein the processor is further configured to:
track each step of the integration process in real time by utilizing a user interface.

16. The system of claim 9, wherein the persistent flow context represents a durable blueprint of the integration process, and the processor is further configured to:
detect errors in the integration process;
automatically notify a user of the dynamic flow executor the detected errors; and
execute automatic retries to resolve the detected errors.

17. A non-transitory computer readable medium configured to store instructions for integrating disparate systems, the instructions, when executed, cause a processor to perform the following:
creating configurable and reusable components designed to adapt to diverse integration needs of the disparate systems within an integration process;
generating a custom script corresponding to each component that defines how the configurable and reusable components are interconnected utilizing integration patterns;
implementing a dynamic flow executor within an integration framework that translates the custom script into actionable integration process components corresponding to the configurable and reusable components by applying the integration patterns and constructing a persistent flow context;
generating tokens to orchestrate execution of the actionable integration process components, wherein the tokens indicate a precise order of execution of the actionable integration process components as defined by the custom script; and
dynamically and automatically integrating the disparate systems based on executing the tokens and the persistent flow context.

18. The non-transitory computer readable medium of claim 17, wherein the configurable and reusable components correspond to integration blocks for integrating the disparate systems by exposing the integration process as configuration-as-code.

19. The non-transitory computer readable medium of claim 18, wherein one of the configurable and reusable components is a representational state transfer integration component within the integration process that exposes one or more configuration options.

20. The non-transitory computer readable medium of claim 19, wherein in exposing one or more configuration options, the instructions, when executed, cause the processor to further perform the following:
exposing an endpoint specifying a universal resource locator of a representational state transfer service to connect with corresponding to the representational state transfer integration component;
defining a type of hypertext transport protocol request to be used;
configuring a type of authentication needed to integrate the disparate systems; and
setting rules for validating responses received from the representational state transfer service.
